(19) United States
(12) Patent Application Publication
(10) Pub. No.: US 2025/0193564 A1
(43) Pub. Date: Jun. 12, 2025

(54) ARRAY MICROPHONE DEVICE

(71) Applicant: PANASONIC INTELLECTUAL PROPERTY MANAGEMENT CO., LTD., Osaka (JP)

(72) Inventor: Shinji KURAOKA, Fukuoka (JP)

(21) Appl. No.: 18/955,658

(22) Filed: Nov. 21, 2024

(30) Foreign Application Priority Data
Dec. 6, 2023 (JP) 2023-206253

(51) Int. Cl. H04R 1/02; H04R 1/40

(52) U.S. Cl. CPC H04R 1/02; H04R 1/406; H04R 2201/021

(57) ABSTRACT

An array microphone device is disposed at an opening portion of a system ceiling instead of a first ceiling panel. The first ceiling panel is disposed at the opening portion of a grid body in the system ceiling. The array microphone device includes a device main body housing an array microphone; and a frame fixed to the device main body and is disposed at the opening portion. The frame disposed at the opening portion supports the device main body by retracting a main body front surface of the device main body upward in a vertical direction relative to a panel front surface of a second ceiling panel which is a surface on a lower side in the vertical direction. The second ceiling panel constitutes the system ceiling and is disposed at another opening portion of the system ceiling.

### CROSS-REFERENCE TO RELATED APPLICATIONS

This application is based on and claims priority under 35 USC 119 from Japanese Patent Application No. 2023-206253 filed on Dec. 6, 2023, the contents of which are incorporated herein by reference.

### TECHNICAL FIELD

The present disclosure relates to an array microphone device.

### BACKGROUND ART

Patent Literature 1 discloses an array microphone system that includes a substrate and a plurality of microphones arranged on the substrate in the form of nested concentric rings of various sizes. In the array microphone system, each ring includes a subset of a plurality of microphones positioned at a predetermined interval along a peripheral portion of the ring. The array microphone system includes an array microphone that is a microphone assembly and includes the plurality of microphones, and a housing configured to support the array microphone. The housing has a size and a shape which allow the housing to be attached inside a hanging ceiling instead of at least one ceiling panel among a plurality of ceiling panels included in the hanging ceiling. The microphone assembly that includes a sound-permeable screen having substantially the same size and shape as those of at least one ceiling panel among the plurality of ceiling panels is provided on a front surface of the housing.

### CITATION LIST

### Patent Literature

Patent Literature 1: JP2018-515028A

### SUMMARY OF INVENTION

Since in the microphone assembly (hereinafter, also referred to as an “array microphone device”) the attachment thereof is often an operation at a high place, it is preferable in terms of safety that the operation can favorably be performed. However, when a main body front surface of the array microphone device is flush with a panel front surface of the ceiling panel, the main body front surface comes into contact with a temporary placement surface when the array microphone device is temporarily placed during the attachment operation. When the main body front surface comes into contact with the temporary placement surface, stain or damage is likely to occur. In addition, when the array microphone device is temporarily placed with the main body front surface facing upward, the main body front surface is likely to be stained or damaged due to falling of a foreign matter or the like. Therefore, in the array microphone device in the related art, handling during the attachment operation is complicated, and it is difficult to achieve favorable workability. Such a problem is more remarkable in an array microphone device in which a main body front surface projects downward in a vertical direction relative to a panel front surface. In addition, in the array microphone device in which the main body front surface projects, a ceiling cannot be clearly shown with a good appearance. Further, in the array microphone device in which the main body front surface projects, a shadow due to natural light, illumination light, or the like is likely to be generated on the ceiling, and the appearance of the ceiling is likely to be deteriorated.

The present disclosure is conceived in consideration of such circumstances in the related art described above, and an object thereof is to provide an array microphone device in which a main body front surface can be retracted relative to another panel front surface without impairing directional characteristics of sound collection.

The present disclosure provides an array microphone device to be disposed at an opening portion of a system ceiling instead of a first ceiling panel. The first ceiling panel is disposed at the opening portion of a grid body in the system ceiling. The array microphone device includes a device main body that houses an array microphone, and a frame that is fixed to the device main body and is disposed at the opening portion. The frame disposed at the opening portion supports the device main body by retracting a main body front surface of the device main body upward in a vertical direction relative to a panel front surface of a second ceiling panel in the system ceiling. The panel front surface is a surface on a lower side in the vertical direction. The second ceiling panel is disposed at another opening portion of the system ceiling.

According to the present disclosure, the main body front surface can be retracted relative to the another panel front surface without impairing directional characteristics of sound collection.

### BRIEF DESCRIPTION OF DRAWINGS

FIG. 1 is a perspective view of a system ceiling in a state in which an array microphone device according to Embodiment 1 is disposed at an opening portion, as viewed from a lower side in a vertical direction;

FIG. 2 is a perspective view of the array microphone device shown in FIG. 1, which is disposed at the opening portion, as viewed from an upper side in the vertical direction;

FIG. 3 is a sectional view taken along a line X-X in FIG. 2;

FIG. 4 is an exploded perspective view in a state in which a device main body is retracted upward in the vertical direction from the opening portion of a grid body;

FIG. 5 is a perspective view of a main body front surface of the device main body as viewed from the lower side in the vertical direction;

FIG. 6 is an exploded perspective view of the array microphone device;

FIG. 7 is an exploded perspective view of the device main body;

FIG. 8 is a sectional view taken along a line Y-Y in FIG. 2 including an array central axis; and

FIG. 9 is an enlarged view of a portion A in FIG. 8.

### DESCRIPTION OF EMBODIMENTS

Hereinafter, embodiments specifically disclosing an array microphone device according to the present disclosure will be described in detail with reference to the drawings as appropriate. However, unnecessarily detailed description may be omitted. For example, detailed description of well-known matters and redundant description of substantially the same configuration may be omitted. This is to avoid unnecessary redundancy of the following description and to facilitate understanding of a person skilled in the art. The accompanying drawings and the following description are provided for a person skilled in the art to fully understand the present disclosure and are not intended to limit the subject matters described in the claims.

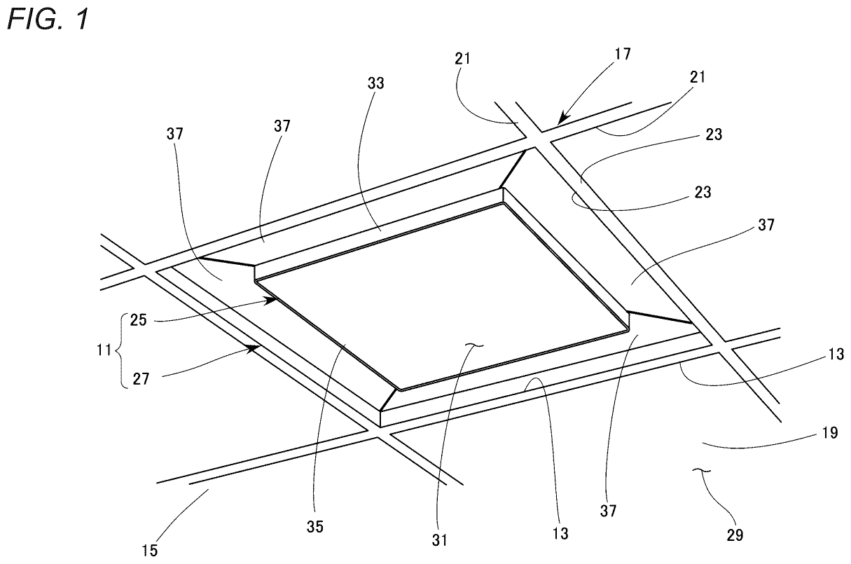

FIG. 1 is a perspective view of a system ceiling 15 in a state in which an array microphone device 11 according to Embodiment 1 is disposed at an opening portion 13, as viewed from a lower side in a vertical direction. In other words, the state in which the array microphone device 11 is disposed at the opening portion 13 may be referred to as a state in which the array microphone device 11 is placed at the opening portion 13, and the same applies to the following description.

The array microphone device 11 according to Embodiment 1 is the array microphone device 11 that is disposed inside the opening portion 13 of the system ceiling 15 instead of a ceiling panel 19, and the ceiling panel 19 is disposed at the opening portion 13 of a grid body 17 in the system ceiling 15. The array microphone device 11 can be suitably used in, for example, a conference room of an office building or a lecture room of a university. However, it is needless to say that a location in which the array microphone device 11 is disposed is not limited to the locations described above.

In the system ceiling 15, the grid body 17 is assembled by T-bars 21 which are parallel to each other at equal intervals in both a longitudinal direction and a lateral direction. The grid body 17 is supported by being suspended from a building skeleton or the like so as to be a horizontal plane. The respective opening portions 13 of the grid body 17 have the same size and the same rectangular shape. In Embodiment 1, the opening portion 13 has a square shape. However, the shape of the opening portion 13 is not limited to the square shape.

In the opening portion 13, a horizontal placement piece portion 23 protrudes inward on each of four sides by a T-bar 21 having an inverted T shape. The ceiling panel 19 is disposed at each of the respective opening portions 13 in a state of being placed on the placement piece portions 23. The array microphone device 11 can be disposed at the opening portion 13 instead of the ceiling panel 19 at any position. The array microphone device 11 includes a device main body 25 that houses a plurality of microphone elements (not shown) constituting an array microphone, and a frame 27 that is fixed to the device main body 25 and is disposed to be placed at the opening portion 13.

The frame 27 placed at the opening portion 13 supports the device main body 25 by retracting a main body front surface 31 of the device main body 25 upward relative to a panel front surface 29 which is a surface of the ceiling panel 19 disposed at another opening portion 13 on the lower side in the vertical direction. In Embodiment 1, the main body front surface 31 is a punching sheet 35 attached to a front surface of a main case 33 of the device main body 25 formed as a rectangular frame. In the array microphone device 11, the frame 27 is assembled by connecting four brackets 37 having the same width and the same length to each other in a manner of corresponding to respective sides of the rectangular frame forming an outer shape of the device main body 25.

In the present description, the front surfaces of the array microphone device 11 and the ceiling panel 19 are surfaces on the lower side in the vertical direction.

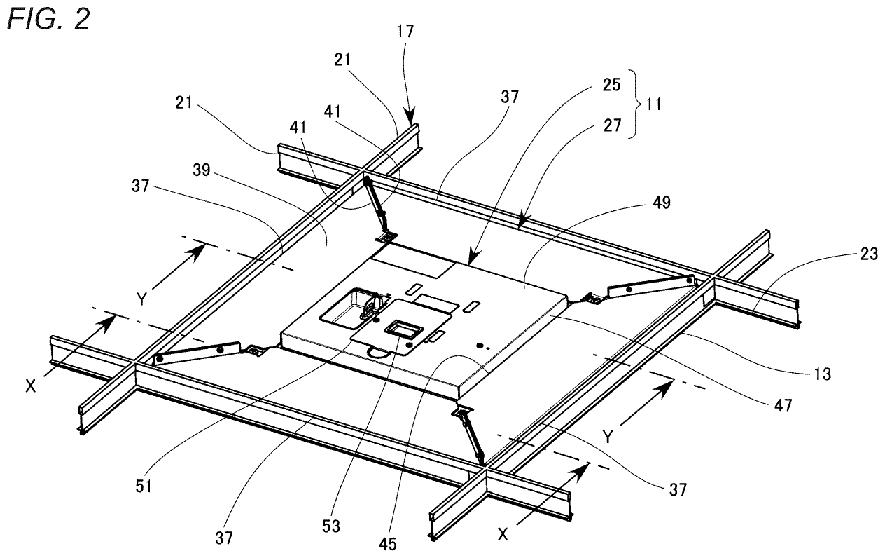

FIG. 2 is a perspective view of the array microphone device 11 shown in FIG. 1, which is disposed at the opening portion 13, as viewed from an upper side in the vertical direction. The four brackets 37 constituting the respective sides of the frame 27 are formed in the same shape. In each of the four brackets 37, both ends of a long side in a horizontal portion 39 in a lengthwise direction are cut at an inclination of about 450 (including 45°) to be inclined end portions. That is, the bracket 37 is a member having a trapezoidal shape. The respective brackets 37 are connected by abutting the inclined end portions against each other in orthogonal directions.

In each of the respective brackets 37, fixation pieces 41 bent upward at a right angle from the horizontal portion 39 are formed on the inclined end portions at both ends of the long side (see the above description). Both ends of the bracket 37 are connected and assembled into the rectangular frame constituting the outer shape of the device main body 25 by fastening and fixing the fixation pieces 41 using screws 43 or the like. An inner hole 45 is formed in the frame 27 assembled into the rectangular frame. A protrusion portion 47 of the device main body 25 is inserted into the inner hole 45 of the frame 27 from the lower side in the vertical direction. The protrusion portion 47 is formed by a connector case 49. A connector cover 51 is detachably attached to the connector case 49. An edge guard 53 is attached to the connector cover 51.

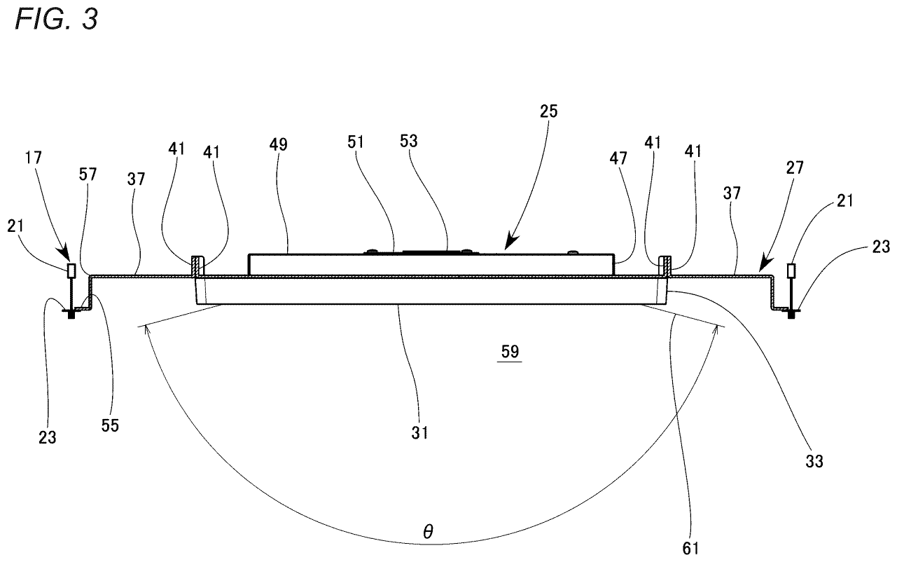

FIG. 3 is a sectional view taken along a line X-X in FIG. 2. The frame 27 has a horizontal flange portion 55 formed on each of the respective brackets 37, and the flange portion 55 is placed on the placement piece portion 23 of the T-bar 21. In the bracket 37, a crank bending portion 57 to be described later is formed above the flange portion 55. In the device main body 25, a lower side of the main body front surface 31 in the vertical direction is a sound collection area 59 of the array microphone device 11. The sound collection area 59 of the array microphone device 11 is generated inside a sound collection boundary 61 determined by a microphone directional angle θ.

In the array microphone device 11, the microphone directional angle θ as a vertical angle of a substantially right circular cone surrounding the sound collection area 59 of the microphone is 150°, for example. This angle may be not limited to 150°.

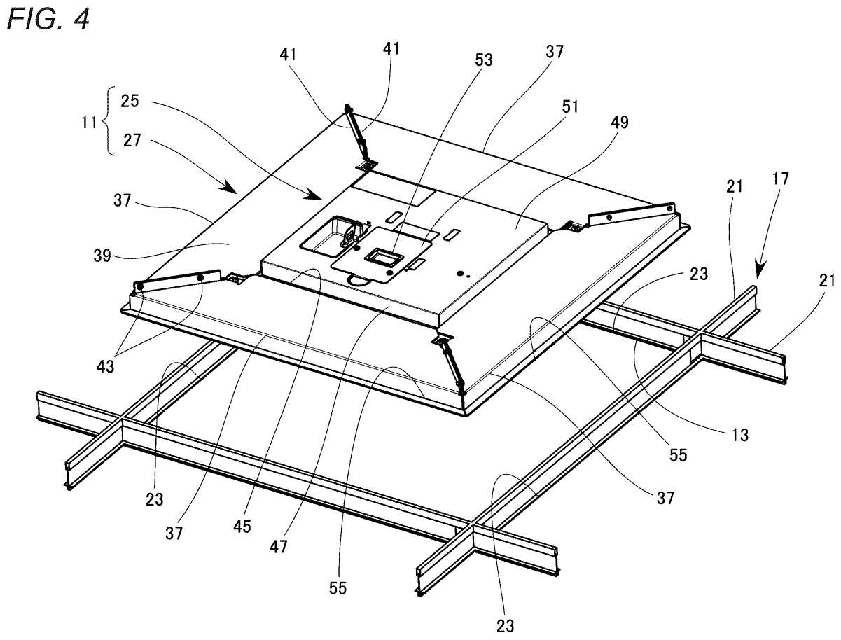

FIG. 4 is an exploded perspective view in a state in which the device main body 25 is retracted upward in the vertical direction from the opening portion 13 of the grid body 17. The grid body 17 is configured by disposing, at equal intervals, a plurality of T-bars 21 parallel to each other in the longitudinal direction and the lateral direction that horizontally extend. The grid body 17 has a plurality of opening portions 13 that have a square shape and are surrounded by the longitudinal and lateral T-bars 21. The ceiling panel 19 (see FIG. 1), which has a square shape and is placed on the placement piece portions 23 formed on the T-bars 21, is dropped into each of the respective opening portions 13. The array microphone device 11 can be placed (in other words, disposed) at the corresponding opening portion 13 instead of any one of the ceiling panels 19 placed at the plurality of opening portions 13.

In the array microphone device 11, the device main body 25 and the frame 27 are integrally assembled by inserting the protrusion portion 47 of the device main body 25 from below into the inner hole 45 of the frame 27 obtained by connecting the brackets 37 on the four sides as the rectangular frame. The array microphone device 11 is supported and attached to the opening portion 13 by placing the flange portions 55 formed on an outer periphery of the frame 27 on the placement piece portions 23 of the T-bars 21 protruding inward from the four sides in the opening portion 13.

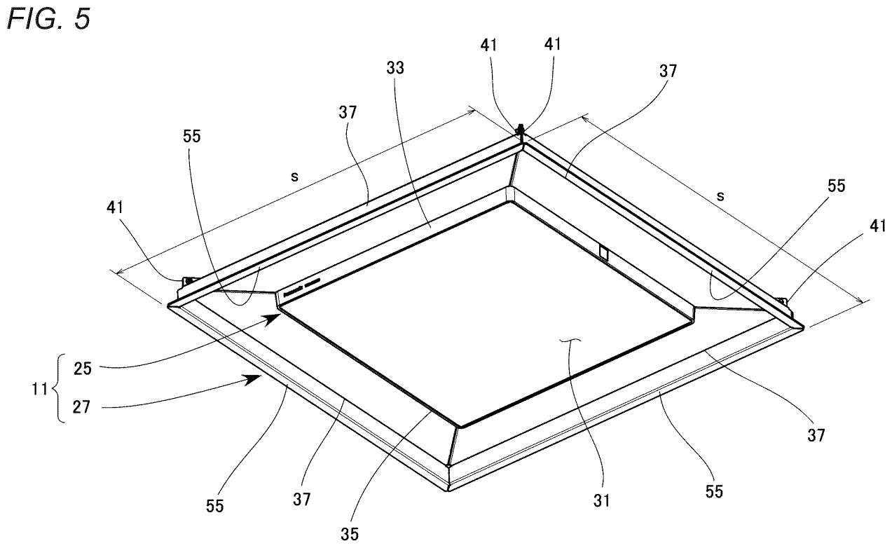

FIG. 5 is a perspective view of the main body front surface 31 of the device main body 25 as viewed from the lower side in the vertical direction. In the array microphone device 11, the flange portions 55 are placed on the placement piece portions 23 of the T-bars 21 shown in FIG. 4. Accordingly, the flange portions 55 and the ceiling panel 19 are placed on the same plane. In the array microphone device 11, the device main body 25 is fixed to the frame 27 on which the flange portions 55 are formed. The frame 27 supports the device main body 25 at a position at which the main body front surface 31 of the device main body 25 is retracted upward relative to the flange portions 55. That is, the main body front surface 31 is disposed to be retracted toward the upper side in the vertical direction relative to the panel front surface 29 of the ceiling panel 19 placed on the another opening portion 13 of the system ceiling 15. The frame 27 has a square outer shape similar to that of the opening portion 13. A length s of one side of the frame 27 may be set to, for example, 604 mm. The length s is not limited to 604 mm.

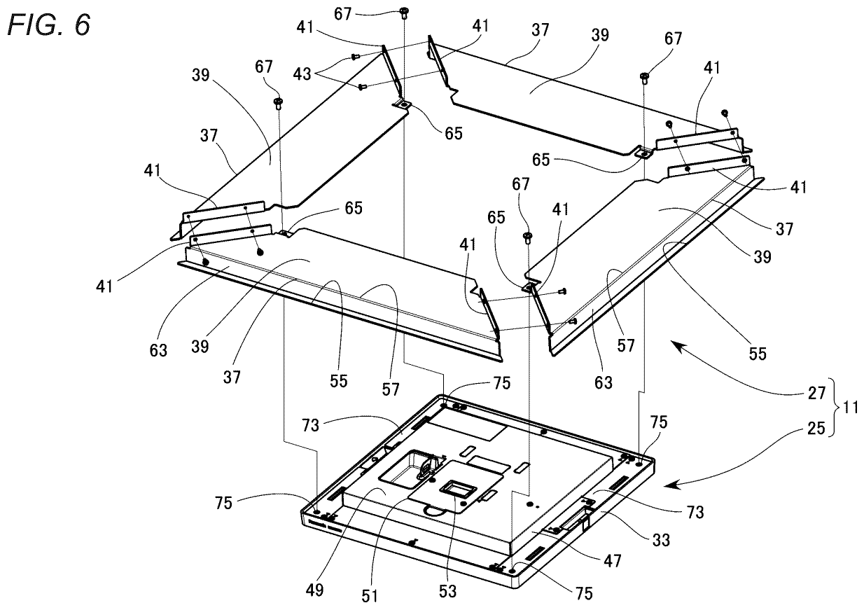

FIG. 6 is an exploded perspective view of the array microphone device 11. In the array microphone device 11, the four brackets 37 constitute the rectangular frame, and the rectangular frame corresponds to the outer shape of the device main body 25. Each of the respective brackets 37 includes the flange portion 55 placed on the placement piece portion 23 of the opening portion 13, an upright portion 63 bent upward at a right angle from the flange portion 55, and the horizontal portion 39 that is bent at a right angle from the upright portion 63 to be parallel to the main body front surface 31 and overlaps the device main body 25. The flange portion 55, the upright portion 63, and the horizontal portion 39 form the crank bending portion 57.

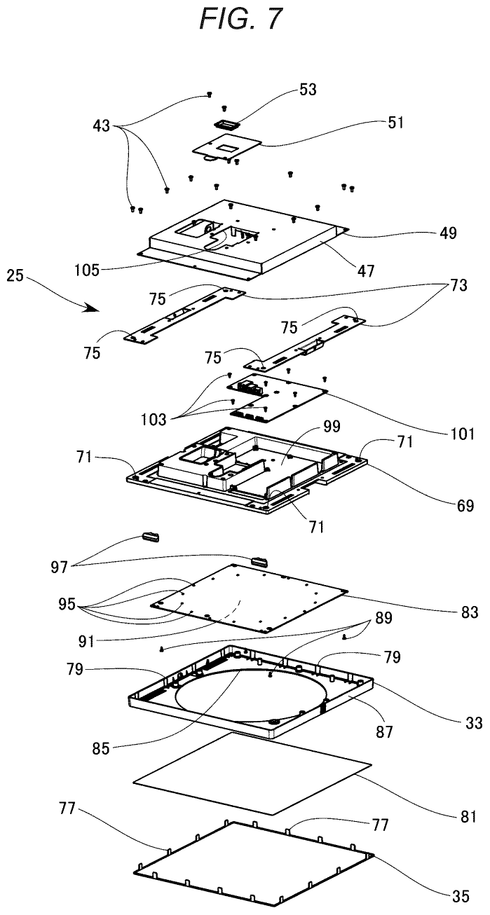

As described above, in each of the respective brackets 37, both ends of the horizontal portion 39 in the lengthwise direction are cut at the inclination of 45° to be the inclined end portions. The fixation pieces 41 bent upward at a right angle stand upright from the inclined end portions. That is, the fixation pieces 41 are provided on both sides of the bracket 37 in the lengthwise direction. In the bracket 37, a horizontal main body fixation piece 65 is formed near one fixation piece 41 of the fixation pieces 41 on both sides. That is, the frame 27 includes one main body fixation piece 65 for each bracket 37, and thus the frame 27 includes four main body fixation pieces 65 in total. Each of the four main body fixation pieces 65 has a screw insertion hole. In the frame 27, a main body fixation screw 67 inserted into the screw insertion hole of the main body fixation piece 65 is fastened to a screw hole 71 (see FIG. 7) formed in an internal chassis 69 (see FIG. 7).

More specifically, the screw holes 71 of the internal chassis 69 are covered with rear cases 73 attached to a part of the internal chassis 69. The main body fixation screw 67 is fastened to the screw hole 71 by passing through a through hole 75 formed in the corresponding rear case 73.

FIG. 7 is an exploded perspective view of the device main body 25. The device main body 25 is assembled by stacking functional components or substrates, structural components or electronic components, cover members, and the like of an array microphone 83. In the device main body 25, the punching sheet 35 having a square shape is attached to the main body front surface 31 as a surface on the lower side in the vertical direction. For example, aluminum is used as a material for the punching sheet 35. The punching sheet 35 has a thickness of about 1 mm and is formed with a large number of small holes. Each side of the punching sheet 35 is provided with a plurality of (for example, four) locking claws 77 protruding upward. The locking claws 77 are locked in locking grooves 79 formed in the main case 33 that is overlapped at an upper layer.

A microphone filter 81 having a square shape is overlapped on an upper layer of the punching sheet 35. The microphone filter 81 captures dust and the like that pass through the punching sheet 35 and adhere to the array microphone 83. In addition, the microphone filter 81 eliminates undesirable noise and reflection due to, for example, an air flow, and facilitates detection of sound from a sound source such as a speaker. For example, a nonwoven fabric is used as a material for the microphone filter 81.

The main case 33 having a square shape is provided on the upper layer of the microphone filter 81. For example, ABS resin is used as a material for the main case 33. The main case 33 is formed in a flat box shape with an opened upper surface. A circular hole 85 centered on an intersection of a pair of diagonal lines is formed in a bottom portion of the main case 33. The circular hole 85 is formed close to a side wall 87 of the main case 33. That is, the circular hole 85 is formed in a size substantially close to an inscribed circle of the main case 33.

The array microphone 83 having a square shape is housed in the main case 33 from above. The array microphone 83 is fixed to a lower surface of the internal chassis 69 overlapped at an upper layer by array fixation screws 89. For example, ABS resin is used as a material for the internal chassis 69. In the array microphone 83 fixed to the lower surface of the internal chassis 69, a sound collection surface 91 is disposed coaxially with the circular hole 85 by housing the internal chassis 69 in the main case 33. The main body front surface 31 (see FIG. 1) is formed in a square shape. The array microphone 83 has a square shape smaller than that of the main body front surface 31, and is disposed parallel to and coaxially with the main body front surface 31.

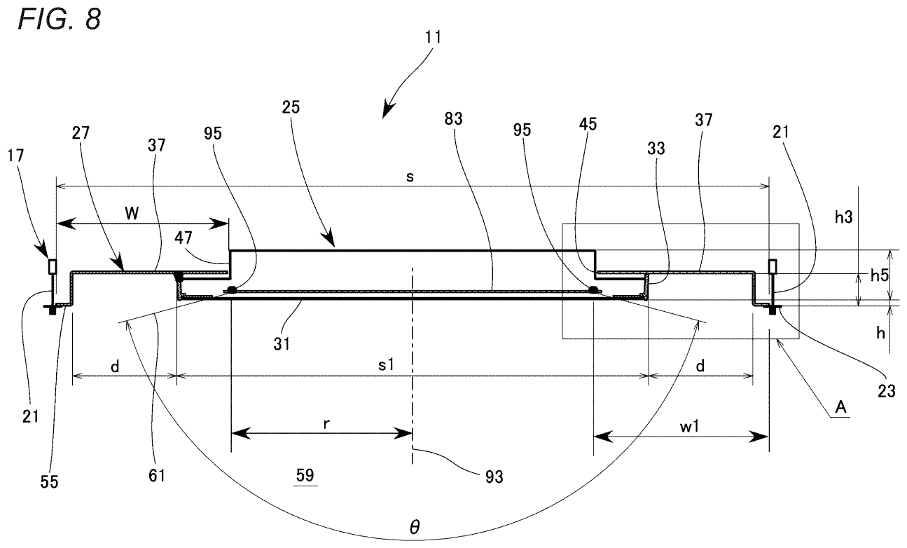

The description “coaxially” means that an array central axis 93 (see FIG. 8), which passes through the center of the array microphone 83 and is perpendicular to the array microphone 83, passes through the center of the main body front surface 31. The center of the array microphone 83 is an intersection of two diagonal lines orthogonal to each other in the array microphone 83 formed in a square shape. Sides of the array microphone 83 and the main body front surface 31, which are coaxially disposed in parallel, are further disposed in parallel, respectively.

The array microphone 83 is provided with a plurality of microphones 95 in a circumferential direction of at least one concentric circle around the array central axis 93. The respective microphones 95 are mounted on an upper surface of the array microphone 83, and the lower side in the vertical direction penetrating the array microphone 83 is a sound collection direction. The array microphone 83 may be provided with an indicator that displays an operation mode of the array microphone device 11. The indicator includes a light-emitting diode (not shown) such as an LED mounted on the upper surface of the array microphone 83, LED lenses 97, and the like.

A substrate housing space 99 is formed on an upper surface of the internal chassis 69. A control substrate 101 is housed in the substrate housing space 99. The control substrate 101 is fixed to the internal chassis 69 by substrate fixation screws 103. The control substrate 101 controls operations of the array microphone 83 and the indicator. The control substrate 101 controls parameters such as sound collection characteristics, directivity, gain, noise reduction, and muting of the array microphone 83.

The upper surface of the internal chassis 69 on which the control substrate 101 is housed in the substrate housing space 99 is covered with the pair of rear cases 73 at portions along a pair of parallel side portions. For example, aluminum is used as a material for the rear cases 73. In addition, various connectors (not shown) constituting an external interface are fixed to the upper surface of the internal chassis 69. For example, the connector includes a universal serial bus (USB) connector, a mini-USB connector, an HDMI (registered trademark) connector, and a power source connector.

The control substrate 101, the rear cases 73, and the connectors are covered with the connector case 49 fixed to the internal chassis 69 from above the internal chassis 69. A connector window 105 for exposing the connectors provided in the internal chassis 69 is formed in the connector case 49. The connector cover 51 is attached to the connector window 105. The edge guard 53 for protecting edge terminals of the connectors is attached to the connector cover 51. The connector cover 51, the connector case 49, the rear cases 73, and the like are fixed to an adherend such as the internal chassis 69 by the screws 43.

FIG. 8 is a sectional view taken along a line Y-Y in FIG. 2 including the array central axis 93. In each of the respective microphones 95 arranged on the concentric circle of the array microphone 83, a vertical angle of a substantially right circular cone having a vertex at the microphone 95 and a circular bottom surface on a lower side is a microphone directional angle θ. In the array microphone 83, each of the plurality of microphones 95 arranged in the circumferential direction of the concentric circle around the array central axis 93 has the microphone directional angle θ. Accordingly, the array microphone 83 as a whole generates a beam pattern having a cardioid polarity inside a conical surface in which the array central axis 93 passes through the vertex. A vertical angle of the conical surface is 150° as an example of Embodiment 1, which is equal to the microphone directional angle θ.

In the array microphone device 11, relative positions of the microphones 95 and the device main body 25 are set such that the sound collection boundary 61 at the microphone directional angle θ of the array microphone 83 as a whole is located at a position not interfering with lower ends of the T-bars 21 constituting the grid body 17 or the flange portions 55 of the frame 27. Accordingly, the array microphone 83 facilitates removal of unnecessary sound sources and reflected sounds in the environment.

More specifically, a length s1 of one side of the main case 33 can be set to 400 mm. A length d from the main case 33 to the flange portion 55 can be set to 88 mm. A length w of the bracket 37 in a width direction can be set to 145 mm. A length h from the placement piece portion 23 of the T-bar 21 to the main body front surface 31 can be set to 5 mm. A height h3 from the placement piece portion 23 of the T-bar 21 to an upper end of the main case 33 can be set to 27.3 mm. A height h5 from the main body front surface 31 to an upper surface of the protrusion portion 47 can be set to 42.3 mm.

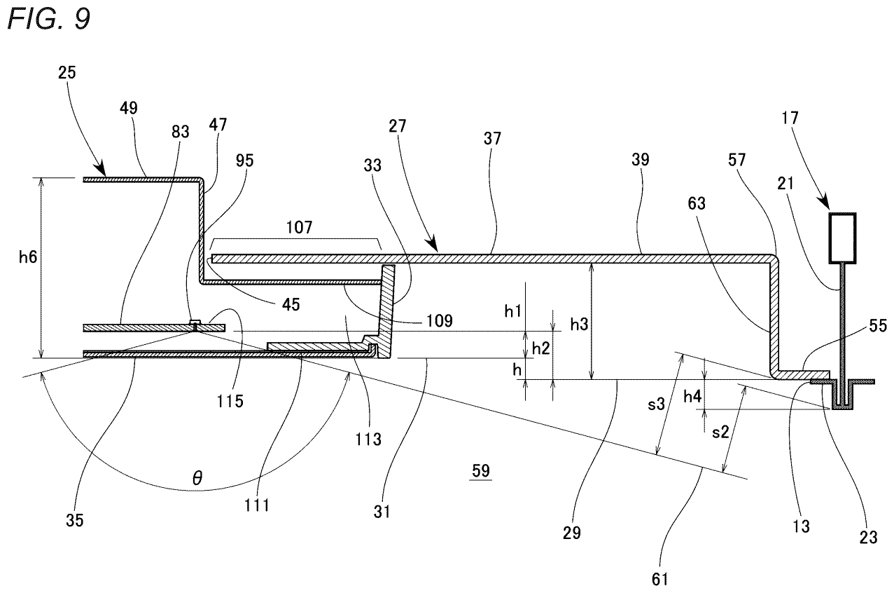

FIG. 9 is an enlarged view of a portion A in FIG. 8. In the array microphone device 11, the device main body 25 has the protrusion portion 47 protruding upward from the inner hole 45 provided in the rectangular frame of the frame 27. The protrusion portion 47 is formed with a projection portion 107 horizontally protruding outward from an outer periphery of the protrusion portion 47 and overlapping lower sides of the horizontal portions 39. The projection portion 107 protrudes from sides of the protrusion portion 47 having a rectangular shape. The projection portion 107 has a space sandwiched between a projection plate 109 of the connector case 49 and a case bottom plate 111 of the main case 33. This space is an annular space 113 surrounded by the main case 33.

In the device main body 25, the inside of the protrusion portion 47 serves as a housing space for the electronic components. The array microphone 83 has an outer shape size larger than that of the housing space. An outer edge 115 of the array microphone 83 protruding from the housing space is inserted and housed in the annular space 113 as the inside of the projection portion 107.

Specifically, a height h1 from the main body front surface 31 to the array microphone 83 can be set to 6.3 mm. A height h2 from the placement piece portion 23 to the array microphone 83 can be set to 11.3 mm. A height h4 from the flange portion 55 to the lower end of the T-bar 21 can be set to 7 mm. A height h6 from the main body front surface 31 to the upper surface of the protrusion portion 47 can be set to 42.3 mm. A shortest distance s2 from the lower end of the T-bar 21 to the sound collection boundary 61 can be set to 21 mm. A shortest distance s3 from the flange portion 55 to the sound collection boundary 61 can be set to 24.4 mm.

The values of d, h, h1, h2, h3, h4, h5, h6, s, s1, s2, s3, and w described above are examples, and the configuration of the array microphone device 11 according to Embodiment 1 is not limited to the values.

Next, effects of the configuration described above will be described.

The array microphone device 11 according to Embodiment 1 is disposed at the opening portion 13 of the system ceiling 15 instead of the ceiling panel 19, and the ceiling panel 19 is disposed at the opening portion 13 of the grid body 17 in the system ceiling 15. The array microphone device 11 includes the device main body 25 that houses the array microphone 83, and the frame 27 that is fixed to the device main body 25 and is placed at the opening portion 13. The frame 27 disposed at the opening portion 13 supports the device main body 25 by retracting the main body front surface 31 of the device main body 25 upward relative to the panel front surface 29 which is the surface of the ceiling panel 19 disposed at another opening portion 13 constituting the system ceiling on the lower side in the vertical direction.

The array microphone device 11 according to Embodiment 1 can be placed at any opening portion 13 of the system ceiling 15 without being fixed. The array microphone device 11 includes the device main body 25 and the frame 27. The device main body 25 houses the array microphone 83. The array microphone 83 is a microphone substrate in which the plurality of microphones 95 are arranged on a printed wiring substrate (PC). The frame 27 is fixed to the device main body 25 and is placed at the opening portion 13.

The frame 27 placed at the opening portion 13 supports the device main body 25 by retracting a main body front surface 31 of the device main body 25 upward relative to a panel front surface 29 which is a surface of the ceiling panel 19 disposed at another opening portion 13 on the lower side in the vertical direction. The flange portions 55 placed on the placement piece portions 23 of the T-bars 21 are formed on the four sides of the frame 27. The frame 27 is disposed in a state of being placed on the opening portion 13 by placing the flange portions 55 on the placement piece portions 23 of the T-bars 21.

In each flange portion 55, the upright portion 63 is bent upward at a right angle from the flange portion 55, and the horizontal portion 39 is bent from an upper end of the upright portion 63 in a horizontal direction parallel to the flange portion 55. The device main body 25 is fixed to the horizontal portions 39 of the frame 27.

Accordingly, in the array microphone device 11, a distance by which the main body front surface 31 is retracted upward increases as a height of the upright portion 63 increases, and the distance by which the main body front surface 31 is retracted upward decreases as the height of the upright portion 63 decreases. In the array microphone device 11, by mainly setting the height of the upright portion 63, the device main body 25 is supported by retracting the main body front surface 31 upward relative to the panel front surface 29 of the ceiling panel 19 disposed at another opening portion 13 without impairing directional characteristics of sound collection.

The structure in which the main body front surface 31 is retracted upward by the upright portions 63 is an example. A structure may be used in which the main body front surface 31 is retracted upward by changing a height of another portion, for example, the main case 33.

The main body front surface 31 of the device main body 25 is retracted upward relative to the flange portions 55 of the frame 27, and thus the main body front surface 31 does not come into contact with a temporary placement surface even when the array microphone device 11 is temporarily placed on the flat temporary placement surface during the attachment operation. That is, a gap is secured between the main body front surface 31 and the temporary placement surface by retracting the main body front surface 31 upward.

Therefore, stain or damage due to the contact of the main body front surface 31 with the temporary placement surface does not occur. In addition, the array microphone device 11 can be temporarily placed with the main body front surface 31 facing downward, and thus the main body front surface 31 is not stained or damaged due to falling of a foreign matter or the like. Accordingly, the array microphone device 11 is easy to handle, and favorable attachment workability is obtained.

In addition, as compared with an array microphone device in the related art in which the main body front surface 31 projects, the main body front surface 31 is retracted upward relative to the panel front surface 29, and thus it is possible to clearly show the ceiling with a good appearance.

Further, as compared with the array microphone device in the related art in which the main body front surface 31 projects, a shadow due to natural light, illumination light, or the like is not formed on the ceiling, and the appearance of the ceiling is not deteriorated.

In addition, in the array microphone device 11, the frame 27 is assembled by connecting the four brackets 37 having the same width and the same length to each other in a manner of corresponding to the respective sides of the rectangular frame forming the outer shape of the device main body 25.

In the array microphone device 11, the frame 27 is assembled by connecting the four brackets 37 to each other in a manner of corresponding to the respective sides of the rectangular frame. That is, the frame 27 is a rectangular frame that has a square shape and the square inner hole 45. A part of the device main body 25 is inserted into the inner hole 45 of the rectangular frame and is fixed. The flange portions 55, which are horizontally bent outward, are formed on the respective sides of the frame 27. In the frame 27 as the rectangular frame, the flange portions 55 are placed on the placement piece portions 23 of the T-bars 21 at the opening portion 13 of the grid body 17. Accordingly, the device main body 25 is placed at the opening portion 13 of the system ceiling 15 via the frame 27.

For example, one side s of the frame 27 as the rectangular frame is set to 604 mm. Regarding the brackets 37 constituting the respective sides, a width w orthogonal to a length direction of the side s is set to 145 mm, for example. That is, each bracket 37 is an elongated plate having a length of approximately 600 mm and the width of 145 mm. The brackets 37 can be manufactured by sheet metal processing.

Accordingly, the array microphone device can be packaged in a state in which the device main body 25 and the frame 27 are separated and the frame 27 is further separated into four portions. Therefore, a package size of the array microphone device can be reduced as compared with a case in which an assembled product of 604 mm×604 mm is packaged. Accordingly, transportation costs can be reduced, and labors for storage and carrying-in and carrying-out can be reduced.

Further, in the array microphone device 11, each bracket 37 has the crank bending portion 57 including the flange portion 55 placed on the placement piece portion 23 of the opening portion 13, the upright portion 63 bent upward at a right angle from the flange portion 55, and the horizontal portion 39 that is bent at a right angle from the upright portion 63 to be parallel to the main body front surface 31 and overlaps the device main body 25.

In the array microphone device 11, the bracket 37 as the elongated plate has the crank bending portion 57 including the flange portion 55, the upright portion 63, and the horizontal portion 39. In the crank bending portion 57, an end of the horizontal flange portion 55 is connected to the vertical upright portion 63, and an upright tip of the upright portion 63 is connected to the horizontal portion 39 which is horizontally provided. That is, the flange portion 55 forms the crank bending portion 57 in which rectangular bent portions at two opposite positions are close to each other.

On the other hand, the bracket 37 as the elongated plate can also be manufactured to a structure that has a Z-bent portion including the flange portion 55, an inclined portion (not shown), and the horizontal portion 39. That is, the upright portion 63 can be manufactured as the inclined portion. However, such a Z-bent portion in which both ends in an inclination direction are bent at an obtuse angle at two opposite positions is difficult to achieve dimensional accuracy, is low in strength, and is difficult to maintain the shape. On the other hand, according to the bracket 37 formed with the crank bending portion 57 in which the rectangular bent portions at two opposite positions are close to each other, high dimensional accuracy is easily achieved, the strength is high, and shape deformation due to spring back after manufacturing can be restrained.

Further, in the array microphone device 11, each bracket 37 has the fixation pieces 41 bent upward at a right angle from the horizontal portion 39 at both ends in a direction along one side of the rectangular frame, and the four brackets 37 are assembled into the rectangular frame by fastening the fixation pieces 41.

In the array microphone device 11, the frame 27 is assembled by connecting the four brackets 37 as the elongated plates along the respective sides of the rectangular frame to each other. In the frame 27, the four divided brackets 37 are fixed to each other by the fixation pieces 41 at four corners, and thus the four brackets 37 can be easily fixed from one surface side of the rectangular frame. In addition to this, the four pairs of fixed fixation pieces 41 are along diagonal lines that are orthogonal to each other, and a high-strength assembly in which the rectangular frame is hardly deformed is obtained.

Further, in the array microphone device 11, the main body front surface 31 is formed in a square shape, the array microphone 83 has a square shape smaller than that of the main body front surface 31, and is disposed parallel to and coaxially with the main body front surface 31, the array microphone 83 is provided with the plurality of microphones 95 in the circumferential direction of the at least one concentric circle around the array central axis 93 passing through the center of the array microphone 83 and perpendicular to the array microphone 83, and the sound collection area 59 of the microphone 95, which is surrounded by the conical surface of the substantially right circular cone having the vertex at the microphone 95 and the circular bottom surface on the lower side, does not interfere with the lower ends of the T-bars 21 constituting the grid body 17.

In the array microphone device 11, the array microphone 83 is housed in the device main body 25. The array microphone 83 and the main body front surface 31 have square shapes. The array microphone 83 and the main body front surface 31 are disposed in parallel and coaxially.

The array microphone 83 is provided with the plurality of microphones 95 in the circumferential direction of the at least one concentric circle around the array central axis 93. Each of the respective microphones 95 has the sound collection area 59 surrounded by the conical surface of the substantially right circular cone having the vertex at the microphone 95 and the circular bottom surface on the lower side.

In the state in which the array microphone device 11 is placed at the opening portion 13 of the grid body 17, the sound collection area 59 passing through the main body front surface 31 has a structure that does not interfere with the lower ends of the T-bars 21 constituting the grid body 17. This no-interference structure is determined based on the microphone directional angle θ, a horizontal distance w1 (see FIG. 8) between the microphone 95 and the T-bar 21, and a height difference (h+h1+h4) between the microphones 95 and the lower ends of the T-bars 21. The horizontal distance w1 between the microphone 95 and the T-bar 21 can be set to a variable value within a range with which the sound collection area 59 does not interfere with other members, and an example of a specific dimension is omitted.

In the array microphone device 11, the sound collection area 59 has the structure that does not interfere with the frame 27 or the grid body 17, and thus the main body front surface 31 can be retracted relative to another panel front surface 29 without impairing the microphone directional angle of the microphones 95.

Further, in the array microphone device 11, the microphone directional angle as the vertical angle of the substantially right circular cone surrounding the sound collection area 59 of the microphone 95 is 150°.

In the array microphone device 11, the plurality of microphones 95 are provided in the circumferential direction of the at least one concentric circle around the array central axis 93 passing through the center of the array microphone 83 and perpendicular to the array microphone 83. In each of the microphones 95, the vertical angle of the substantially right circular cone having the vertex at the microphone 95 and the circular bottom surface on the lower side is the microphone directional angle θ. In the array microphone 83, each of the plurality of microphones 95 arranged in the circumferential direction of the concentric circle around the array central axis 93 has the microphone directional angle θ. Accordingly, the array microphone 83 as a whole generates a beam pattern having a cardioid polarity inside a conical surface in which the array central axis 93 passes through the vertex. The vertical angle of the conical surface is 150°, which is equal to the microphone directional angle θ. Accordingly, the array microphone 83 facilitates removal of unnecessary sound sources and reflected sounds in the environment.

In addition, in the array microphone device 11, the device main body 25 includes the protrusion portion 47 protruding upward from the inner hole 45 formed in the rectangular frame of the frame 27, the protrusion portion 47 is formed with the projection portion 107 protruding outward from the outer periphery of the protrusion portion 47 and overlapping the lower sides of the horizontal portions 39, and the outer edge 115 of the array microphone 83 is housed inside the projection portion 107.

In the array microphone device 11, the protrusion portion 47 of the device main body 25 is inserted from the lower side into the inner hole 45 of the frame 27 formed as the rectangular frame. The protrusion portion 47 has the projection portion 107 protruding outward from the outer periphery. The projection portion 107 overlaps the lower side of the horizontal portion 39 in each of the brackets 37 constituting the four sides of the frame 27. The projection portion 107 has the annular space 113. The device main body 25 houses the outer edge 115 of the array microphone 83 protruding from the housing space of protrusion portion 47.

Accordingly, in the array microphone device 11, the horizontal distance w1 between the microphone 95 and the T-bar 21 can be set to be small within a range in which the sound collection area 59 of the microphone 95 does not interfere with the T-bars 21. That is, since the annular space 113 is provided, the sound collection area 59 (specifically, a radius r of the concentric circle) can be secured as large as possible without impairing the directional characteristics of the sound collection. In this case (in the case of securing the sound collection area 59 as large as possible), the case bottom plate 111 is set to an appropriate length at a design stage so as not to block the sound collection area 59.

Therefore, according to the array microphone device 11 of Embodiment 1, the main body front surface 31 can be retracted relative to another panel front surface 29 without impairing the directional characteristics of the sound collection.

### Techniques of the Present Disclosure

As described above, the present disclosure discloses the following technical ideas.

### (Technique 1)

An array microphone device to be placed at an opening portion of a system ceiling instead of a first ceiling panel, the first ceiling panel being placed at the opening portion of a grid body in the system ceiling, the array microphone includes:
a device main body housing an array microphone; and
a frame fixed to the device main body and placed at the opening portion, in which
the frame disposed at the opening portion supports the device main body by retracting a main body front surface of the device main body upward in a vertical direction relative to a panel front surface of a second ceiling panel in the system ceiling. The panel front surface is a surface on a lower side in the vertical direction. The second ceiling panel is disposed at another opening portion of the system ceiling.

### (Technique 2)

The array microphone device according to (Technique 1), in which
the frame is assembled by connecting four brackets having the same width and the same length to each other in a manner of corresponding to respective sides of a rectangular frame.

### (Technique 3)

The array microphone device according to (Technique 1) or (Technique 2), in which
each bracket has a crank bending portion including a flange portion placed on a placement piece portion of the opening portion, an upright portion bent upward at a right angle from the flange portion, and a horizontal portion that is bent at a right angle from the upright portion to be parallel to the main body front surface and overlaps the device main body.

### (Technique 4)

The array microphone device according to any one of (Technique 1) to (Technique 3), in which
each bracket has fixation pieces bent upward at a right angle from the horizontal portion at both ends in a direction along one side of the rectangular frame, and
the four brackets are assembled into the rectangular frame by fastening the fixation pieces.

### (Technique 5)

The array microphone device according to any one of (Technique 1) to (Technique 4), in which
the main body front surface is formed in a square shape,
the array microphone has a square shape smaller than that of the main body front surface, and is disposed parallel to and coaxially with the main body front surface,
the array microphone is provided with a plurality of microphones in a circumferential direction of at least one concentric circle around an array central axis perpendicular to the array microphone, and
a sound collection area of each microphone, which is surrounded by a conical surface of a substantially right circular cone having a vertex at the microphone and a circular bottom surface on a lower side, does not interfere with a lower end of a T-bar constituting the grid body.

### (Technique 6)

The array microphone device according to (Technique 5), in which
a microphone directional angle as a vertical angle of the substantially right circular cone surrounding the sound collection area of the microphone is 150°.

### (Technique 7)

The array microphone device according to (Technique 3), in which
the device main body includes a protrusion portion protruding upward from an inner hole formed in the rectangular frame of the frame,
the protrusion portion is formed with a projection portion protruding outward from an outer periphery of the protrusion portion and overlapping a lower side of the horizontal portion, and
an outer edge of the array microphone is housed inside the projection portion.

Although various embodiments have been described above with reference to the accompanying drawings, the present disclosure is not limited thereto. It is apparent to a person skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the various embodiments described above may be combined freely in a range without deviating from the spirit of the invention.

### INDUSTRIAL APPLICABILITY

The present disclosure is useful as an array microphone device that can retract a main body front surface relative to another panel front surface without impairing directional characteristics of sound collection.

What is claimed is:

1. An array microphone device to be disposed at an opening portion of a system ceiling instead of a first ceiling panel, the first ceiling panel being disposed at the opening portion of a grid body in the system ceiling, the array microphone device comprising:
a device main body that houses an array microphone; and
a frame that is fixed to the device main body and is disposed at the opening portion, wherein
the frame disposed at the opening portion supports the device main body by retracting a main body front surface of the device main body upward in a vertical direction relative to a panel front surface of a second ceiling panel in the system ceiling, the panel front surface being a surface on a lower side in the vertical direction, the second ceiling panel being disposed at another opening portion of the system ceiling.

2. The array microphone device according to claim 1, wherein
the frame is assembled by connecting four brackets having a same width and a same length to each other in a manner of corresponding to respective sides of a rectangular frame forming an outer shape of the device main body.

3. The array microphone device according to claim 2, wherein
each of the four brackets has a crank bending portion,
the crank bending portion includes a flange portion placed on a placement piece portion of the opening portion, an upright portion bent upward at a right angle from the flange portion, and a horizontal portion that is bent at a right angle from the upright portion to be parallel to the main body front surface and overlaps the device main body.

4. The array microphone device according to claim 3, wherein
each of the four brackets has fixation pieces bent upward at a right angle from the horizontal portion at both ends in a direction along one side of the rectangular frame, and
the four brackets are assembled into the rectangular frame by fastening the fixation pieces.

5. The array microphone device according to claim 1, wherein
the main body front surface is formed in a square shape,
the array microphone has a square shape smaller than that of the main body front surface, and is disposed parallel to and coaxially with the main body front surface,
the array microphone is provided with a plurality of microphones in a circumferential direction of at least one concentric circle around an array central axis perpendicular to the array microphone, and
a sound collection area of each of the microphones, which is surrounded by a conical surface of a substantially right circular cone having a vertex at the microphone and a circular bottom surface on a lower side, does not interfere with a lower end of a T-bar constituting the grid body.

6. The array microphone device according to claim 5, wherein
a microphone directional angle as a vertical angle of the substantially right circular cone surrounding the sound collection area of the microphone is 150°.

7. The array microphone device according to claim 3, wherein
the device main body includes a protrusion portion protruding upward from an inner hole formed in the rectangular frame of the frame,
the protrusion portion is formed with a projection portion protruding outward from an outer periphery of the protrusion portion and overlapping a lower side of the horizontal portion, and
an outer edge of the array microphone is housed inside the projection portion.
